(19) United States
(12) Patent Application Publication
(10) Pub. No.: US 2024/0396378 A1
(43) Pub. Date: Nov. 28, 2024

(54) CHARGING DEVICE AND CHARGING METHOD

(71) Applicant: Panasonic Automotive Systems Co., Ltd., Kanagawa (JP)

(72) Inventors: Motohiro SHIMIZU, Kanagawa Ken (JP); Yoshio YUSE, Kanagawa Ken (JP); Toshiaki SEKI, Kanagawa Ken (JP)

(73) Assignee: Panasonic Automotive Systems Co., Ltd., Kanagawa (JP)

(21) Appl. No.: 18/795,520

(22) Filed: Aug. 6, 2024

Related U.S. Application Data
(63) Continuation of application No. PCT/JP2023/001416, filed on Jan. 18, 2023.

(30) Foreign Application Priority Data
Feb. 9, 2022 (JP) 2022-018366

(51) Int. Cl. H02J 50/60; H02J 7/00; H02J 50/10; H02J 50/90

(52) U.S. Cl. CPC H02J 50/60; H02J 7/007188; H02J 50/10; H02J 50/90

(57) ABSTRACT

A charging device is configured to perform wireless charging on a terminal device including a power receiver that receives wirelessly transmitted electric power. The charging device includes a control circuit configured to: cause a power transmitter to transmit electric power; acquire magnitude of transmitted power; acquire magnitude of received power received by the terminal device; detect a position at which the power receiver of the terminal device is placed; set a threshold for determining whether to stop wireless charging in accordance with the received power and the position at which the power receiver is placed; and determine whether to continue or stop charging based on a comparison between the transmitted power and the threshold.

### CROSS-REFERENCE TO RELATED APPLICATIONS

This application is a continuation of International Application No. PCT/JP2023/001416, filed on Jan. 18, 2023 which claims the benefit of priority of the prior Japanese Patent Application No. 2022-18366, filed on Feb. 9, 2022, the entire contents of which are incorporated herein by reference.

### FIELD

The present disclosure relates to a charging device and a charging method.

### BACKGROUND

In recent years, there is known a charging device that performs non-contact charging for a terminal device such as a smartphone (for example, JP 2020-513728 A). In such a charging device, induced electromotive force is caused by electromagnetic induction by causing magnetic flux generated by an alternating current flowing through a power transmission coil to pass through a power reception coil incorporated in a terminal device placed on a charging stand. The terminal device is then charged by the induced electromotive force generated in the power reception coil.

The charging device disclosed in JP 2020-513728 A detects that a metallic foreign object is held between the charging device and a terminal device based on magnitude of power loss calculated based on a relation between transmitted power and received power. However, the power loss is cased even if the terminal device is placed in a state in which a center position of the power transmission coil is deviated from a center position of the power reception coil, so that it has been impossible to determine whether the power loss is caused by the foreign object or a positional relation between the coils.

An object of the present disclosure is to provide a charging device and a charging method that can improve accuracy in detection of a foreign object between a charging device and a terminal device irrespective of a positional relation between a power transmission coil and a power reception coil.

### SUMMARY

A charging device according to the present disclosure is configured to perform wireless charging on a terminal device including a power receiver that receives wirelessly transmitted electric power. The charging device includes a control circuit configured to: cause a power transmitter to transmit electric power; acquire magnitude of transmitted power; acquire magnitude of received power received by the terminal device; detect a position at which the power receiver of the terminal device is placed; set a threshold for determining whether to stop wireless charging in accordance with the received power and the position at which the power receiver is placed; and determine whether to continue or stop charging based on a comparison between the transmitted power and the threshold.

### BRIEF DESCRIPTION OF THE DRAWINGS

FIG. 1 is a block diagram illustrating an example of a schematic configuration of a charging device according to a first embodiment;

FIG. 2A is a diagram for explaining a transmission/reception amount of electric power in a case in which a foreign object is present between a power transmission coil and a power reception coil;

FIG. 2B is a diagram for explaining a transmission/reception amount of electric power in a case in which position deviation is caused between the power transmission coil and the power reception coil;

FIG. 3 is a diagram for explaining a method for determining a foreign object detection threshold to stop charging in accordance with position deviation between the power transmission coil and the power reception coil;

FIG. 4 is a diagram illustrating an example of a foreign object detection threshold setting table for determining the foreign object detection threshold to stop charging in accordance with position deviation between the power transmission coil and the power reception coil;

FIG. 5 is a functional block diagram illustrating an example of a functional configuration of the charging device according to the first embodiment;

FIG. 6 is a flowchart illustrating an example of a procedure of processing performed by the charging device according to the first embodiment;

FIG. 7 is a diagram for explaining a method for updating a foreign object detection threshold by a charging device according to a second embodiment;

FIG. 8 is a diagram illustrating a state in which a charging possible range is widened by the charging device according to the second embodiment;

FIG. 9 is a functional block diagram illustrating an example of a functional configuration of the charging device according to the second embodiment; and

FIG. 10 is a flowchart illustrating an example of a procedure of processing performed by the charging device according to the second embodiment.

### DETAILED DESCRIPTION

### First Embodiment

The following describes a first embodiment of a charging device according to the present disclosure with reference to the drawings.

### (Schematic Configuration of Charging Device)

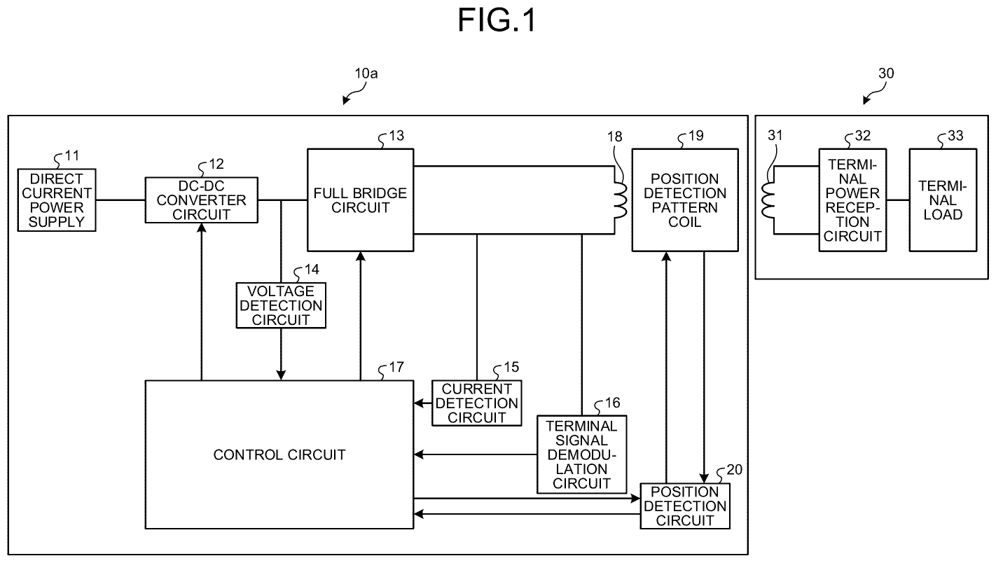

The following describes a schematic configuration of a charging device 10a with reference to FIG. 1. FIG. 1 is a block diagram illustrating an example of a schematic configuration of the charging device according to the first embodiment.

The charging device 10a performs non-contact charging on a terminal device 30. The terminal device 30 is, for example, a smartphone. The charging device 10a includes a direct current power supply 11, a DC-DC converter circuit 12, a full bridge circuit 13, a voltage detection circuit 14, a current detection circuit 15, a terminal signal demodulation circuit 16, a control circuit 17, a power transmission coil 18 (Tx coil), a position detection pattern coil 19, and a position detection circuit 20.

The direct current power supply 11 supplies direct current power to operate the charging device 10a.

The DC-DC converter circuit 12 steps up or down a direct current voltage of the direct current power supply 11 to a predetermined direct current voltage.

The full bridge circuit 13 converts the direct current voltage, which has been stepped up or down by the DC-DC converter circuit 12, into an alternate current voltage.

The voltage detection circuit 14 detects the direct current voltage stepped up or down by the DC-DC converter circuit 12.

The current detection circuit 15 detects an output current of the full bridge circuit 13.

The terminal signal demodulation circuit 16 demodulates information acquired from the terminal device 30 through communication between the charging device 10a and the terminal device 30. The terminal signal demodulation circuit 16 also transmits the demodulated information to the control circuit 17. The charging device 10a communicates with the terminal device 30 based on the Qi standard.

The control circuit 17 applies the alternate current voltage to the power transmission coil 18 by controlling operations of the DC-DC converter circuit 12 and the full bridge circuit 13.

The power transmission coil 18 causes induced electromotive force in a power reception coil 31 based on a principle of electromagnetic induction in response to the alternate current voltage applied from the full bridge circuit 13. The power transmission coil 18 is an example of a power transmission unit (power transmitter) in the present disclosure.

When receiving a PING signal from the position detection circuit 20, the position detection pattern coil 19 transmits, to the position detection circuit 20, a reflected wave that varies in accordance with a coupling state between the position detection pattern coil 19 and the power reception coil 31.

The position detection circuit 20 acquires the reflected wave from the position detection pattern coil 19, and detects a center position of the power reception coil 31.

The terminal device 30 includes the power reception coil 31 (Rx coil), a terminal power reception circuit 32, and a terminal load 33.

The power reception coil 31 generates induced electromotive force due to electromagnetic induction by approaching the power transmission coil 18 to which the alternate current voltage is applied. The power reception coil 31 is an example of a power reception unit (power reception unit) in the present disclosure.

The terminal power reception circuit 32 generates a charging current corresponding to the induced electromotive force generated in the power reception coil 31.

The terminal load 33 is, for example, a battery, and charged with an output current from the terminal power reception circuit 32.

The charging device 10a charges the battery of the terminal device 30 by transmitting electric power between the power transmission coil 18 and the power reception coil 31.

### (Positional Relation Between Tx Coil and Rx Coil)

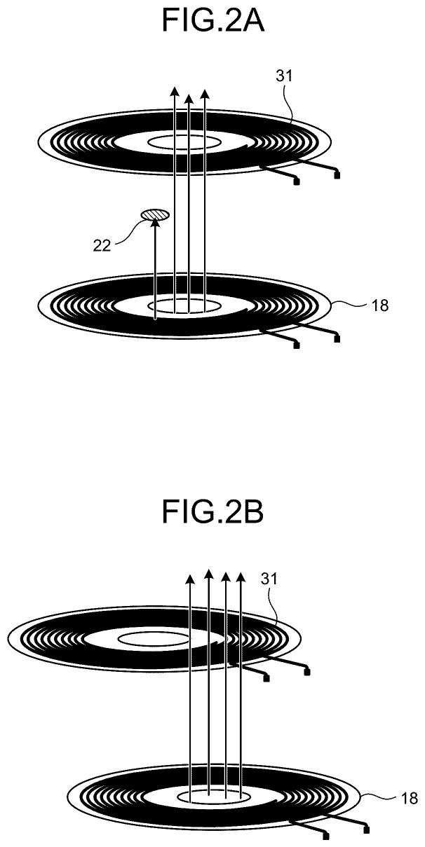

The following describes a schematic configuration of the charging device 10a with reference to FIG. 2A and FIG. 2B. FIG. 2A is a diagram for explaining a transmission/reception amount of electric power in a case in which a foreign object is present between the power transmission coil and the power reception coil. FIG. 2B is a diagram for explaining a transmission/reception amount of electric power in a case in which position deviation is caused between the power transmission coil and the power reception coil.

As illustrated in FIG. 2A, when a metallic foreign object 22 is present between the power transmission coil 18 and the power reception coil 31, a power loss is caused between transmitted power transmitted by the power transmission coil 18 and received power received by the power reception coil 31.

In a case of FIG. 2A, the metallic foreign object 22 is held between the power transmission coil 18 and the power reception coil 31, so that efficiency of magnetic coupling between the power transmission coil 18 and the power reception coil 31 has been lowered, that is, part of magnetic flux (upward arrows in FIG. 2A) generated in the power transmission coil 18 has not reached the center position of the power reception coil 31. Part of the magnetic flux generated in the power transmission coil 18 then reaches the metallic foreign object 22, and is absorbed by the metallic foreign object 22.

For example, in FIG. 2A, it is assumed that transmitted power of the charging device 10a is 14.5 W, and received power of the power reception coil 31 is 10 W. A certain power loss is caused between the transmitted power of the power transmission coil 18 and the received power of the power reception coil 31 even in a case in which the metallic foreign object is not present. This power loss is assumed to be 2 W. The transmitted power of the charging device 10a then loses 2 W due to the power loss, and further loses 2.5 W due to the metallic foreign object 22.

The metallic foreign object 22 absorbs the electric power of 2.5 W to generate heat. Due to such heat generation by the metallic foreign object 22, there is a possibility of getting burned by touching the charging device 10a or the terminal device 30, or causing ignition by the metallic foreign object 22, so that charging by the charging device 10a is typically stopped in a case in which a loss of the transmitted power exceeds a threshold.

On the other hand, FIG. 2B illustrates a state in which charging is performed while center positions of the power transmission coil 18 and the power reception coil 31 are deviated from each other.

In FIG. 2B, it is assumed that the transmitted power of the charging device 10a is 14.5 W, and the received power of the power reception coil 31 is 10 W. Also in this case, a normal power loss of 2 W is caused. In a case of FIG. 2B, the center position of the power transmission coil 18 is deviated from the center position of the power reception coil 31, so that the efficiency of magnetic coupling has been lowered, that is, part of the magnetic flux (upward arrows in FIG. 2B) generated in the power transmission coil 18 has not reached the center position of the power reception coil 31. A power loss of 2.5 W is then caused due to the position deviation between the power transmission coil 18 and the power reception coil 31.

Comparing FIG. 2A with FIG. 2B, the power loss due to the metallic foreign object 22 is equal to the power loss due to the position deviation between the power transmission coil 18 and the power reception coil 31. In a case in which the power loss is caused by the position deviation between the power transmission coil 18 and the power reception coil 31, heat generation by the metallic foreign object 22 is not caused, so that charging is not required to be stopped.

The charging device 10a according to the present embodiment detects that a power loss is caused by position deviation between the center position of the power transmission coil 18 and the center position of the power reception coil 31. In a case of detecting that a power loss is caused by position deviation between the center position of the power transmission coil 18 and the center position of the power reception coil 31, the charging device 10a controls transmitted power and a threshold for stopping charging in accordance with magnitude of the position deviation.

(Charging Control Method in Accordance with Position Deviation Between Power Transmission Coil and Power Reception Coil)

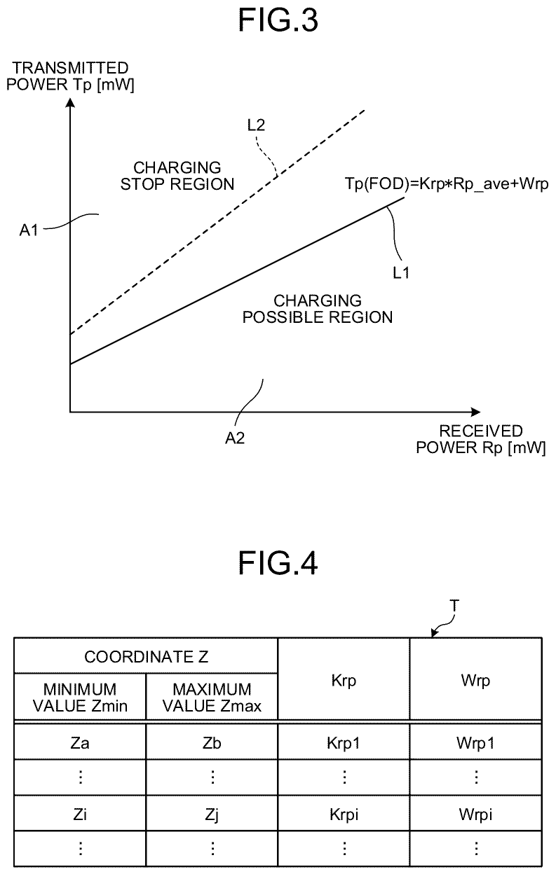

The following describes a method for performing charging control by determining a foreign object detection threshold corresponding to position deviation between the power transmission coil 18 and the power reception coil 31 with reference to FIG. 3 and FIG. 4. FIG. 3 is a diagram for explaining a method for determining the foreign object detection threshold to stop charging in accordance with position deviation between the power transmission coil and the power reception coil. FIG. 4 is a diagram illustrating an example of a threshold setting table for determining the foreign object detection threshold to stop charging in accordance with position deviation between the power transmission coil and the power reception coil.

It is assumed that the transmitted power of the power transmission coil 18 is Tp (mW), and the received power of the power reception coil 31 is Rp (mW). An average value of received power Rp during a predetermined time is assumed to be average received power Rp_ave (mW).

Assuming that the foreign object detection threshold for the metallic foreign object 22 is Tp(FOD), the foreign object detection threshold Tp(FOD) is defined by the expression (1) using a constant Krp and a constant Wrp. The foreign object detection threshold Tp(FOD) is an example of a threshold in the present disclosure.

$$Tp ( FOD ) = Krp * Rp\_ave + Wrp \qquad ( 1 )$$

The expression (1) can be illustrated like a straight line L1 in FIG. 3.

For example, when the transmitted power during charging is A (W) and the received power is B (W), the foreign object detection threshold Tp(FOD) is represented by the expression (2).

$$Tp ( FOD ) = Krp * B + Wrp \qquad ( 2 )$$

If Tp(FOD)>A is satisfied, the charging device 10a determines that the metallic foreign object 22 is not present, and continues charging.

On the other hand, if Tp(FOD)≤A is satisfied, the charging device 10a determines that the metallic foreign object 22 is present, and stops charging.

That is, in a case in which the transmitted power Tp and the received power Rp falls into a charging possible region A2 in FIG. 3, the charging device 10a continues charging. On the other hand, in a case in which the transmitted power Tp and the received power Rp falls into a charging stop region A1 in FIG. 3, the charging device 10a stops charging.

Next, the following describes a method for setting the constant Krp and the constant Wrp with reference to FIG. 4. FIG. 4 is an example of a foreign object detection threshold setting table T for setting the constant Krp and the constant Wrp described above. The constant Krp and the constant Wrp are set in accordance with a positional relation between the power transmission coil 18 and the power reception coil 31 at the time when the terminal device 30 is placed on the charging stand. The foreign object detection threshold setting table T is created by performing an evaluation experiment and the like in advance, and stored in the control circuit 17.

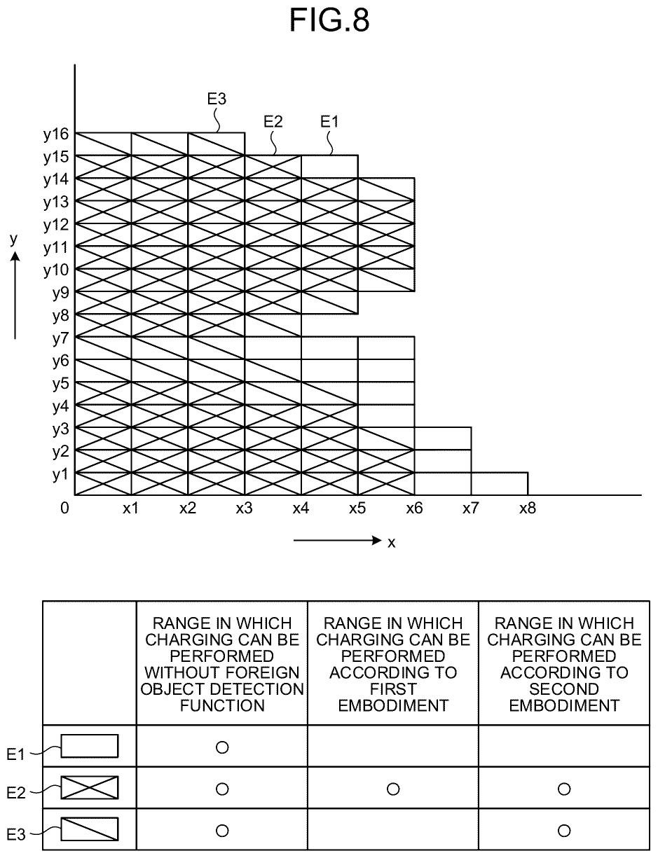

A coordinate Z illustrated in FIG. 4 is a coordinate value in a coordinate system (x, y) (refer to FIG. 8) for specifying a two-dimensional position of the charging stand on which the terminal device 30 is placed. That is, the coordinate Z may be one coordinate value x of the coordinate system xy, or the other coordinate value y.

A position (x, y) of the power reception coil 31 placed on the charging stand is detected by the position detection circuit 20 (refer to FIG. 1).

As illustrated in FIG. 4, in a case in which the power reception coil 31 is positioned in a range from Za to Zb, the constant Krp is set as Krp=Krp1. The constant Wrp is set as Wrp=Wrp1.

It is assumed that, when the center position of the power transmission coil 18 agrees with the center position of the power reception coil 31, the foreign object detection threshold Tp(FOD) is represented as the straight line L1 in FIG. 3. At this point, when the center position of the power transmission coil 18 is deviated from the center position of the power reception coil 31, the constants Krp and Wrp included in the foreign object detection threshold Tp(FOD) vary in accordance with FIG. 4. As a result, the straight line indicated by the foreign object detection threshold Tp(FOD) becomes a straight line L2 in FIG. 3, for example. As the position deviation between the center position of the power transmission coil 18 and the center position of the power reception coil 31 increases, deviation between the straight line L1 and the straight line L2 increases.

### (Functional Configuration of Charging Device)

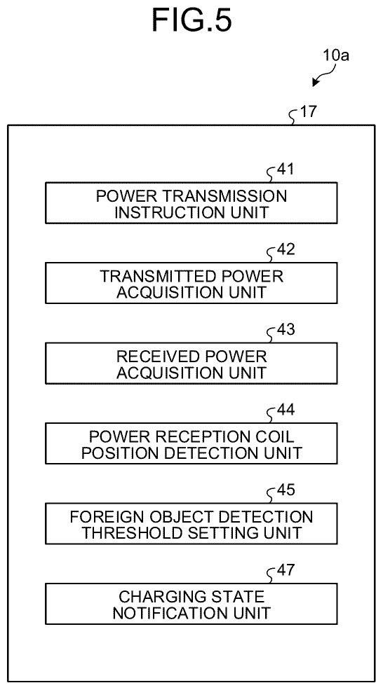

The following describes a functional configuration of the charging device 10a with reference to FIG. 5. FIG. 5 is a functional block diagram illustrating an example of the functional configuration of the charging device according to the first embodiment.

The control circuit 17 of the charging device 10a includes functional parts illustrated in FIG. 5. That is, the control circuit 17 includes a power transmission instruction unit 41, a transmitted power acquisition unit 42, a received power acquisition unit 43, a power reception coil position detection unit 44, a foreign object detection threshold setting unit 45, and a charging state notification unit 47.

The power transmission instruction unit 41 causes the power transmission coil 18 to transmit charging power. The power transmission instruction unit 41 also causes the power transmission coil 18 to stop transmission of the charging power. Specifically, the power transmission instruction unit 41 causes the DC-DC converter circuit 12 and the full bridge circuit 13 to operate to apply an alternate current voltage to the power transmission coil 18.

The transmitted power acquisition unit 42 acquires magnitude of the transmitted power Tp made transmitted by the power transmission instruction unit 41. Specifically, the transmitted power acquisition unit 42 calculates magnitude of the transmitted power Tp based on the direct current voltage acquired from the voltage detection circuit 14 and the output current of the full bridge circuit 13 detected by the current detection circuit 15.

The received power acquisition unit 43 acquires magnitude of the received power Rp received by the terminal device 30. Specifically, when the terminal signal demodulation circuit 16 demodulate information received from the terminal device 30, the received power acquisition unit 43 calculates the magnitude of the received power Rp included in the information received from the terminal device 30.

The power reception coil position detection unit 44 detects the position at which the power reception coil 31 of the terminal device 30 is placed. Specifically, the power reception coil position detection unit 44 acquires the position at which the power reception coil 31 is placed detected by the position detection circuit 20 based on an output from the position detection pattern coil 19. The power reception coil position detection unit 44 is an example of a position detection unit in the present disclosure.

The foreign object detection threshold setting unit 45 sets the foreign object detection threshold Tp(FOD) for determining whether to stop wireless charging in accordance with the received power Rp and the position at which the power reception coil 31 is placed. Specifically, the foreign object detection threshold setting unit 45 sets the constants Krp and Wrp based on the position at which the power reception coil 31 is placed and the foreign object detection threshold setting table T in FIG. 4. The foreign object detection threshold setting unit 45 then sets the foreign object detection threshold Tp(FOD) by substituting the set constants Krp and Wrp into the expression (1). The foreign object detection threshold setting unit 45 is an example of a threshold setting unit in the present disclosure.

The charging state notification unit 47 determines whether to continue or stop charging based on a comparison between the transmitted power Tp and the foreign object detection threshold Tp(FOD) (threshold). The charging state notification unit 47 is an example of a determination unit in the present disclosure. The charging state notification unit 47 makes a notification about an operation state of the charging device 10a. The operation state of the charging device 10a is that, for example, charging is stopped or charging is completed. The notification is made by display or sound. The notification is, for example, made by an indicator, a monitor, a buzzer, a speaker, or the like not illustrated in FIG. 1.

### (Procedure of Processing Performed by Charging Device)

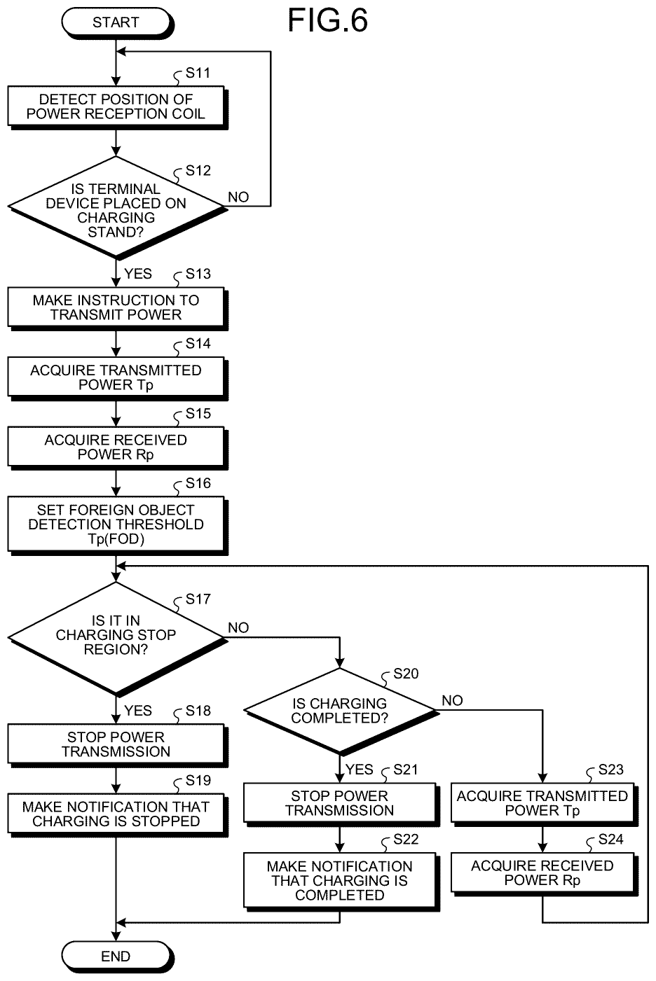

The following describes a procedure of processing performed by the charging device 10a with reference to FIG. 6. FIG. 6 is a flowchart illustrating an example of the procedure of the processing performed by the charging device according to the first embodiment.

The power reception coil position detection unit 44 detects the position of the power reception coil 31 of the terminal device 30 (Step S11).

The power reception coil position detection unit 44 determines whether the terminal device 30 is placed on the charging stand (Step S12). If it is determined that the terminal device 30 is placed on the charging stand (Yes at Step S12), the process proceeds to Step S13. On the other hand, if it is not determined that the terminal device 30 is placed on the charging stand (No at Step S12), the process returns to Step S11.

At Step S12, if it is determined that the terminal device 30 is placed on the charging stand, the power transmission instruction unit 41 instructs the power transmission coil 18 to transmit charging power (Step S13).

The transmitted power acquisition unit 42 acquires the transmitted power Tp of the power transmission coil 18 based on a voltage value acquired from the voltage detection circuit 14 and a current value acquired from the current detection circuit 15 (Step S14).

The received power acquisition unit 43 acquires the received power Rp of the power reception coil 31 by demodulating the information received from the terminal device 30 by the terminal signal demodulation circuit 16 (Step S15).

The foreign object detection threshold setting unit 45 sets the foreign object detection threshold Tp(FOD) by referring to the foreign object detection threshold setting table T corresponding to the position of the power reception coil 31 detected by the power reception coil position detection unit 44 (Step S16).

The charging state notification unit 47 determines whether a current charging state falls into the charging stop region A1 based on the transmitted power Tp, the received power Rp, and the foreign object detection threshold Tp(FOD) (Step S17). If it is determined that the current charging state falls into the charging stop region A1 (Yes at Step S17), the process proceeds to Step S18. On the other hand, if it is not determined that the current charging state falls into the charging stop region A1 (No at Step S17), the process proceeds to Step S20.

At Step S17, if it is determined that the current charging state falls into the charging stop region A1, the power transmission instruction unit 41 causes the power transmission coil 18 to stop transmission of the charging power (Step S18).

The charging state notification unit 47 makes a notification indicating that the charging is stopped (Step S19). Thereafter, the charging device 10a ends the processing in FIG. 6.

At Step S17, if it is not determined that the current charging state falls into the charging stop region A1, the charging state notification unit 47 determines whether the charging is completed (Step S20). If it is determined that the charging is completed (Yes at Step S20), the process proceeds to Step S21. On the other hand, if it is not determined that the charging is completed (No at Step S20), the process proceeds to Step S23.

At Step S20, if it is determined that the charging is completed, the power transmission instruction unit 41 causes the power transmission coil 18 to stop transmission of the charging power (Step S21).

The charging state notification unit 47 makes a notification indicating that the charging is completed (Step S22). Thereafter, the charging device 10a ends the processing in FIG. 6.

At Step S20, if it is not determined that the charging is completed, the transmitted power Tp of the power transmission coil 18 is acquired based on the voltage value acquired from the voltage detection circuit 14 and the current value acquired from the current detection circuit 15 (Step S23).

Next, the received power acquisition unit 43 acquires the received power Rp of the power reception coil 31 by demodulating the information received from the terminal device 30 by the terminal signal demodulation circuit 16 (Step S24). Thereafter, the process returns to Step S17, and the processing described above is repeated.

### Working Effects of Present Embodiment

As described above, the charging device 10a according to the present embodiment performs wireless charging on the terminal device 30 including the power reception coil 31 (power reception unit) that receives wirelessly transmitted electric power, and includes: the power transmission instruction unit 41 that causes the power transmission coil 18 (power transmission unit) to transmit electric power; the transmitted power acquisition unit 42 that acquires magnitude of the transmitted power Tp that has been made transmitted by the power transmission instruction unit 41; the received power acquisition unit 43 that acquires magnitude of the received power Rp received by the terminal device 30; the power reception coil position detection unit 44 (position detection unit) that detects the position at which the power reception coil 31 of the terminal device 30 is placed; the foreign object detection threshold setting unit 45 (threshold setting unit) that sets the foreign object detection threshold Tp(FOD) (threshold) for determining whether to stop wireless charging in accordance with the received power Rp and the position at which the power reception coil 31 is placed; and the charging state notification unit 47 (determination unit) that determines whether to continue or stop charging based on a comparison between the transmitted power Tp and the foreign object detection threshold Tp(FOD). Thus, detection accuracy for the metallic foreign object 22 between the charging device 10a and the terminal device 30 can be improved irrespective of the positional relation between the power transmission coil 18 and the power reception coil 31. Additionally, appropriate power transmission output can be performed irrespective of the positional relation between the power transmission coil 18 and the power reception coil 31, so that the terminal device 30 can be efficiently charged.

### Second Embodiment

The following describes a second embodiment of the charging device according to the present disclosure with reference to the drawings. A charging device 10b according to the second embodiment has a function of successively detecting a placement position of the power reception coil 31, and resetting the foreign object detection threshold Tp(FOD) in a case in which the placement position of the power reception coil 31 moves in a direction toward which the position deviation from the power transmission coil 18 reduces. A hardware configuration of the charging device 10b is the same as the hardware configuration of the charging device 10a described in the first embodiment (refer to FIG. 1), so that the same reference numeral as that in FIG. 1 is used in a case of citing a hardware constituent element.

### (Method for Updating Foreign Object Detection Threshold)

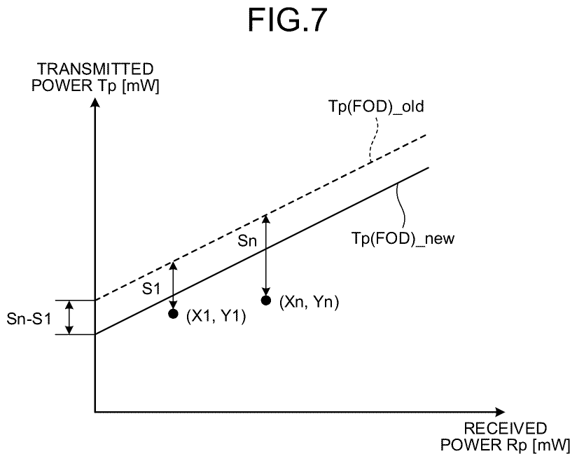

The following describes a method for updating the foreign object detection threshold Tp(FOD) by the charging device 10b with reference to FIG. 7. FIG. 7 is a diagram for explaining the method for updating the foreign object detection threshold by the charging device according to the second embodiment.

A foreign object detection threshold Tp(FOD) old illustrated in FIG. 7 is an example of the foreign object detection threshold Tp(FOD) described in the first embodiment.

After starting charging, the charging device 10b stands by until a time when electric power becomes stable, and measures the transmitted power Tp and the received power Rp. It is assumed that the measured transmitted power is Y1, and the received power is X1. The charging device 10b calculates a difference value S1 of the expression (3) using the foreign object detection threshold Tp(FOD) old that is set at this point.

$$S 1 = ( Krp * X 1 + Wrp ) - Y 1 \qquad ( 3 )$$

The charging device 10b stores the calculated difference value S1. Thereafter, the charging device 10b repeatedly measures the transmitted power Tp and the received power Rp at intervals of 10 seconds, for example. The measured transmitted power Tp is assumed to be Y2, Y3, . . . , Yn, . . . . The measured received power is assumed to be X2, X3, . . . , Xn, . . . .

The charging device 10b measures transmitted power Yi (i=2, 3, . . . , n, . . . ) and received power Xi (i=2, 3, . . . , n, . . . ) at a time when electric power related to charging becomes stable, that is, at time intervals (for example, at intervals of 10 seconds) with which the transmitted power Yi and the received power Xi become stable. The charging device 10b then calculates a difference value Si in the expression (4) every time the transmitted power Yi and the received power Xi are measured.

$$Si = ( Krp * Xi + Wrp ) - Yi \qquad ( 4 )$$

The constant Krp and the constant Wrp in the expression (4) are determined by referring to the foreign object detection threshold setting table T (refer to FIG. 4) corresponding to the position of the power reception coil 31 detected by the power reception coil position detection unit 44.

FIG. 7 illustrates an example of the n-th calculated difference value Sn.

The charging device 10b compares the difference value S1 with the difference value Sn every time the transmitted power Yn and the received power Xn are newly measured. In a case in which the difference value Sn is larger than the difference value S1, that is, in a case in which the center position of the power reception coil 31 is considered to be closer to the center position of the power transmission coil 18, a value obtained by subtracting (Sn−S1) from the constant Wrp is set as a new constant Wrp. Due to this, as illustrated in FIG. 7, the foreign object detection threshold is updated from Tp(FOD)_old to Tp(FOD)_new.

In this way, the charging device 10b successively sets the appropriate foreign object detection threshold Tp(FOD)_new while repeatedly measuring the transmitted power Yi and the received power Xi. Accordingly, the appropriate foreign object detection threshold Tp(FOD)_new can be set in accordance with the positional relation between the power reception coil 31 and the power transmission coil 18.

With reference to FIG. 8, the following describes the fact that the charging device 10b can widen a charging possible region in a state in which a foreign object detection function is enabled as compared with the charging device 10a described in the first embodiment. FIG. 8 is a diagram illustrating a state in which the charging possible range is widened by the charging device according to the second embodiment.

FIG. 8 is a diagram based on an actual evaluation result using the charging device 10b. The coordinate values x and y illustrated in FIG. 8 each represent the position at which the power reception coil 31 of the terminal device 30 is placed on the charging stand. FIG. 8 illustrates a result obtained by evaluating whether the terminal device 30 can be charged in a range from x=x₁ to x=xᵢ₊₁, and a range from y=yⱼ to y=yⱼ₊₁.

A region E1 illustrated in FIG. 8 indicates a region in which the terminal device 30 can be charged without the foreign object detection function. A region E2 indicates a region in which the terminal device 30 can be charged by the charging device 10b according to the second embodiment. A region E3 indicates a region in which the terminal device 30 can be charged by the charging device 10a according to the first embodiment. As can be seen from FIG. 8, the region E3 expands around the region E2. That is, by using the charging device 10b according to the second embodiment, the terminal device 30 can be charged in a state of enabling the foreign object detection function even in a region in which charging cannot be performed by the charging device 10a according to the first embodiment.

### (Functional Configuration of Charging Device)

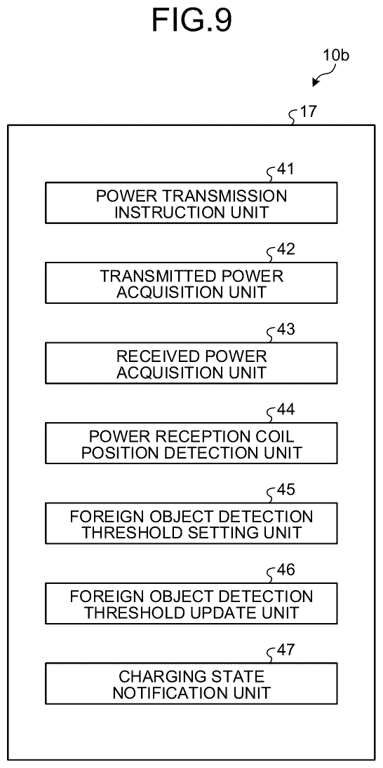

The following describes a functional configuration of the charging device 10b with reference to FIG. 9. FIG. 9 is a functional block diagram illustrating an example of the functional configuration of the charging device according to the second embodiment.

The control circuit 17 of the charging device 10b includes functional parts illustrated in FIG. 9. The control circuit 17 of the charging device 10b includes a foreign object detection threshold update unit 46 in addition to the functional parts included in the control circuit 17 of the charging device 10a.

The foreign object detection threshold update unit 46 updates the foreign object detection threshold Tp(FOD) based on a difference value S between the foreign object detection threshold Tp(FOD) and the transmitted power Tp acquired at predetermined time intervals. The foreign object detection threshold update unit 46 is an example of a threshold update unit in the present disclosure.

The predetermined time interval is a time interval with which electric power related to charging, that is, the transmitted power Yi and the received power Xi both become stable.

The foreign object detection threshold update unit 46 updates the foreign object detection threshold Tp(FOD) in a case in which it is determined that the position deviation between the power transmission coil 18 and the power reception coil 31 has varied in a direction toward which it reduces.

The foreign object detection threshold update unit 46 does not update the foreign object detection threshold Tp(FOD) in a case in which it is determined that the position deviation between the power transmission coil 18 and the power reception coil 31 has not varied, or has varied in a direction toward which it increases.

### (Procedure of Processing Performed by Charging Device)

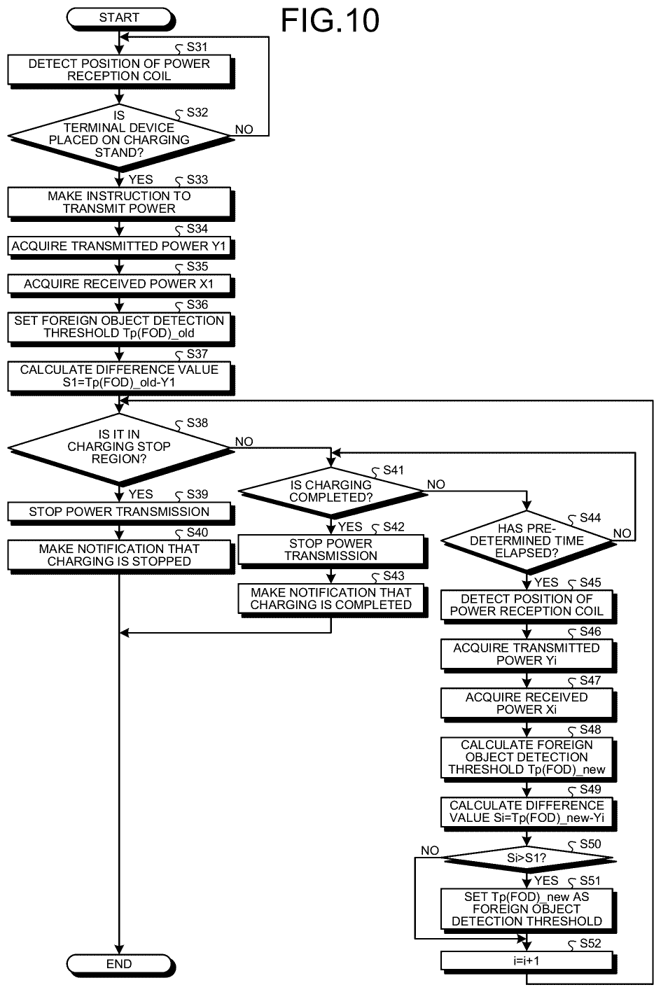

The following describes a procedure of processing performed by the charging device 10b with reference to FIG. 10. FIG. 10 is a flowchart illustrating an example of the procedure of the processing performed by the charging device according to the second embodiment.

Pieces of processing from Step S31 to Step S33 are the same as the pieces of processing performed by the charging device 10a according to the first embodiment (from Step S11 to Step S13 in FIG. 6), so that redundant description will not be repeated.

The transmitted power acquisition unit 42 acquires the transmitted power Y1 of the power transmission coil 18 based on a voltage value acquired from the voltage detection circuit 14 and a current value acquired from the current detection circuit 15 (Step S34).

The received power acquisition unit 43 acquires the received power X1 of the power reception coil 31 by demodulating the information received from the terminal device 30 by the terminal signal demodulation circuit 16 (Step S35).

The foreign object detection threshold setting unit 45 sets the foreign object detection threshold Tp(FOD)_old by referring to the foreign object detection threshold setting table T corresponding to the position of the power reception coil 31 detected by the power reception coil position detection unit 44 (Step S36).

The foreign object detection threshold setting unit 45 calculates the difference value S1=Tp(FOD)_old−Y1 (Step S37).

Hereinafter, pieces of processing from Step S38 to Step S43 are the same as the pieces of processing performed by the charging device 10a according to the first embodiment (from Step S17 to Step S22 in FIG. 6), so that redundant description will not be repeated. The transmitted power acquisition unit 42 stores time when the transmitted power Y1 is acquired at Step S34. The received power acquisition unit 43 stores time when the received power X1 is acquired at Step S35.

At Step S41, if it is not determined that the charging is completed, the foreign object detection threshold update unit 46 determines whether a predetermined time has elapsed since the transmitted power and the received power are acquired (Step S44). If it is determined that the predetermined time has elapsed (Yes at Step S44), the process proceeds to Step S44. On the other hand, if it is not determined that the predetermined time has elapsed (No at Step S44), the process returns to Step S41.

At Step S44, if it is determined that the predetermined time has elapsed, the power reception coil position detection unit 44 detects the position of the power reception coil 31 (Step S45).

Subsequently, the transmitted power acquisition unit 42 acquires the transmitted power Yi of the power transmission coil 18 based on a voltage value acquired from the voltage detection circuit 14 and a current value acquired from the current detection circuit 15 (Step S46). The transmitted power acquisition unit 42 stores time when the transmitted power Yi is acquired at Step S46.

The received power acquisition unit 43 acquires the received power Xi of the power reception coil 31 by demodulating the information received from the terminal device 30 by the terminal signal demodulation circuit 16 (Step S47). The received power acquisition unit 43 stores time when the received power Xi is acquired at Step S47.

The foreign object detection threshold setting unit 45 calculates the foreign object detection threshold Tp(FOD)_new by referring to the foreign object detection threshold setting table T corresponding to the position of the power reception coil 31 detected by the power reception coil position detection unit 44 (Step S48).

The foreign object detection threshold setting unit 45 calculates the difference value Si=Tp(FOD)_new−Yi (Step S49).

The foreign object detection threshold update unit 46 determines whether the difference value Si is larger than the difference value S1 (Step S50). If it is determined that the difference value Si is larger than the difference value S1 (Yes at Step S50), the process proceeds to Step S51. On the other hand, if it is not determined that the difference value Si is larger than the difference value S1 (No at Step S50), the process proceeds to Step S52.

At Step S50, if it is determined that the difference value Si is larger than the difference value S1, the foreign object detection threshold update unit 46 sets the foreign object detection threshold Tp(FOD)_new as a new foreign object detection threshold (Step S51).

The foreign object detection threshold update unit 46 increments a subscript i (Step S52). Thereafter, the process returns to Step S38.

As described above, the charging device 10b according to the present embodiment further includes the foreign object detection threshold update unit 46 (threshold update unit) that updates the foreign object detection threshold Tp(FOD) based on the difference value Si between the foreign object detection threshold Tp(FOD) and the transmitted power Yi acquired at predetermined time intervals. Thus, in a case in which the position of the terminal device 30 is moved during charging, the appropriate foreign object detection threshold Tp(FOD) can be set while maintaining the detection function for the metallic foreign object 22. Due to this, it is possible to widen a placement range in which charging can be performed at the time when the terminal device 30 is placed on the charging stand.

In the charging device 10b according to the present embodiment, the predetermined time interval is a time until the transmitted power Yi and the received power Xi both become stable. Thus, the difference value Si related to the setting of the foreign object detection threshold Tp(FOD) can be calculated more correctly.

In the charging device 10b according to the present embodiment, the foreign object detection threshold update unit 46 (threshold update unit) updates the foreign object detection threshold Tp(FOD) (threshold) in a case in which it is determined that the position deviation between the power transmission coil 18 (power transmission unit) and the power reception coil 31 (power reception unit) varies in a direction toward which it reduces. Thus, in a case in which the terminal device 30 moves in the direction toward which the position deviation between the power transmission coil 18 and the power reception coil 31 reduces, the foreign object detection threshold Tp(FOD) can be updated to be an appropriate value so that the charging can be continued while maintaining the detection function for the metallic foreign object 22. This control can prevent the foreign object detection threshold Tp(FOD) from being inappropriate due to the position deviation of the power reception coil 31, and prevent the metallic foreign object 22 from becoming too hot.

In the charging device 10b according to the present embodiment, the foreign object detection threshold update unit 46 (threshold update unit) does not update the foreign object detection threshold Tp(FOD) (threshold) in a case in which it is determined that the position deviation between the power transmission coil 18 (power transmission unit) and the power reception coil 31 (power reception unit) has not varied, or has varied in a direction toward which it increases. Thus, in a case in which the terminal device 30 moves in the direction toward which the position deviation between the power transmission coil 18 and the power reception coil 31 reduces, or in a case in which the terminal device 30 does not move, the charging can be continued without updating the foreign object detection threshold Tp(FOD).

With the charging device according to the present disclosure, it is possible to improve accuracy in detection of a foreign object between a charging device and a terminal device irrespective of a positional relation between a power transmission coil and a power reception coil.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charging device configured to perform wireless charging on a terminal device including a power receiver that receives wirelessly transmitted electric power, the charging device comprising
a control circuit configured to:
cause a power transmitter to transmit electric power;
acquire magnitude of transmitted power;
acquire magnitude of received power received by the terminal device;
detect a position at which the power receiver of the terminal device is placed;
set a threshold for determining whether to stop wireless charging in accordance with the received power and the position at which the power receiver is placed; and
determine whether to continue or stop charging based on a comparison between the transmitted power and the threshold.

2. The charging device according to claim 1, wherein the control circuit is further configured to update the threshold based on a difference value between the threshold and the transmitted power acquired at a predetermined time interval.

3. The charging device according to claim 2, wherein the predetermined time interval is a time until the transmitted power and the received power both become stable.

4. The charging device according to claim 2, wherein the control circuit is configured to update the threshold in a case in which it is determined that position deviation between the power transmitter and the power receiver has varied in a direction toward which it reduces.

5. The charging device according to claim 2, wherein the control circuit is configured not to update the threshold in a case in which it is determined that position deviation between the power transmitter and the power receiver has not varied, or has varied in a direction toward which it increases.

6. A charging method for performing wireless charging on a terminal device including a power receiver that receives wirelessly transmitted electric power, the charging method comprising:
causing a power transmitter to transmit electric power;
acquiring magnitude of transmitted power made transmitted at the power transmission instruction step;
acquiring magnitude of received power received by the terminal device;
detecting a position at which a power receiver of the terminal device is placed;
a threshold setting step of setting a threshold for determining whether to stop wireless charging in accordance with the received power and the position at which the power receiver is placed; and
a determination step of determining whether to continue or stop charging based on a comparison between the transmitted power and the threshold.

7. The charging method according to claim 6, further comprising a threshold update step of resetting the threshold based on a difference value between the threshold and the transmitted power acquired at a predetermined time interval.
